(19) United States
(12) Patent Application Publication
(10) Pub. No.: US 2010/0251533 A1
(43) Pub. Date: Oct. 7, 2010

(54) SUBMERGED NOZZLE SUPPORTING-REPLACING MECHANISM, AND LOWER-NOZZLE/DIPPED-NOZZLE SEALING METHOD

(76) Inventors: Kenji Yamamoto, Tokyo (JP); Mototsugu Osada, Tokyo (JP)

Correspondence Address: WENDEROTH, LIND & PONACK, L.L.P., 1030 15th Street, N.W.,, Suite 400 East, Washington, DC, 20005-1503, US

(21) Appl. No.: 12/677,924

(22) PCT Filed: Dec. 19, 2008
(86) PCT No.: PCT/JP2008/073190

§ 371 Date: Mar. 12, 2010

(30) Foreign Application Priority Data
Jan. 7, 2008 (JP) 2008-000507

(51) Int. Cl. B23P 19/02

(52) U.S. Cl. 29/525; 29/700

(57) ABSTRACT

To alleviate a bending stress to be applied to a lower nozzle, by joining a ring-shaped taper portion of the lower nozzle to a receiving taper portion of a receiving member, to thereby prevent generation of a vertical cracking, and further to improve a sealing property of the lower nozzle and a submerged nozzle with a seal material, provided are a submerged nozzle supporting-replacing mechanism and a lower-nozzle/submerged-nozzle sealing method, in which, when an upper surface of a submerged nozzle (6) is joined through clampers (5) with respect to a lower surface of a lower nozzle (4) supported by a receiving member (3) of a lower frame (2) of a slide valve device (1), a receiving taper portion (3A) of the receiving member (3) is joined to a ring-shaped taper portion (4A) of the lower nozzle (4), to thereby suppress a vertical cracking.

### TECHNICAL FIELD

The present invention relates to a submerged nozzle supporting-replacing mechanism and a lower-nozzle/submerged-nozzle sealing method. In particular, the present invention relates to a novel improvement for alleviating a bending stress to be applied to a lower nozzle by joining a ring-shaped taper portion of the lower nozzle to a receiving taper portion of a receiving member, to thereby prevent generation of a vertical cracking, and further for sealingly engage a submerged nozzle with respect to the lower nozzle with a seal material provided to a ring-shaped groove.

### BACKGROUND ART

Conventionally, as a lower nozzle in a submerged nozzle supporting-replacing mechanism for rapidly replacing a submerged nozzle with respect to a slide valve device serving as a flow control device from a tundish to a mold, the following conventional structures 1 to 4 are employed.

For example, in the conventional structure 1 of FIG. 9 described in Patent Documents 1 to 3, a slide valve device 1 mainly includes an upper plate 1a, a slide plate 1b, and a lower plate 1c, which are arranged inside a base frame 1A. A lower nozzle 4 is supported by a receiving member 3 provided to a lower frame 2 of the slide valve device 1. Joined to a lower surface 4a of the lower nozzle 4 is a submerged nozzle 6 upwardly biased by clampers 5.

A ring-shaped step portion 7 of the lower nozzle 4 is joined so as to be disposed on the receiving member 3. The ring-shaped step portion 7 is formed into an angular shape having a right angle. The receiving member 3 is also formed into an angular shape having a right angle.

In this structure, the submerged nozzle 6 and a fresh submerged-nozzle 6A can be extruded by an extruding member 9 to the right direction of FIG. 9 on guide rails 8 arranged below the lower frame 2.

Thus, in a state of FIG. 9, molten metal flows through the slide valve device 1, the lower nozzle 4, and the submerged nozzle 6 into an underlying mold (not shown).

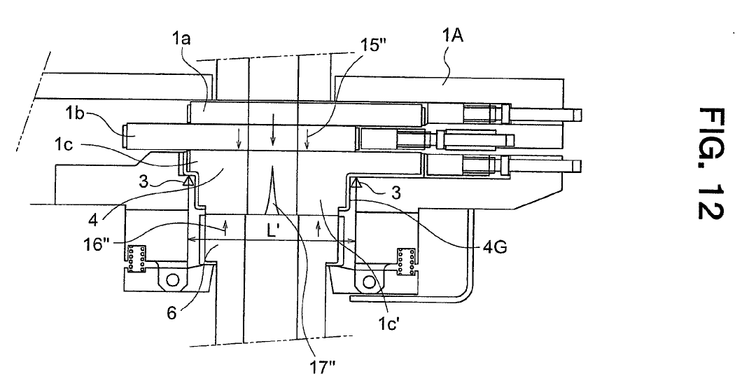

Further, in the conventional structure 2 of FIG. 11, though the parts identical to those of FIG. 9 are denoted by the same reference symbols and the description thereof is omitted, a structure of retaining the lower nozzle 4 is identical to the structure of FIG. 9 between their planes.

Further, in the conventional structure 3 of FIG. 12, though the parts identical to those of FIG. 11 are denoted by the same reference symbols and the description thereof is omitted, the lower plate 1c and the lower nozzle 4 are integrated with each other and are integrally retained by an iron case 4G.

Further, in the conventional structure 4, though the conventional structure 4 is not shown, a seal material described in Patent Document 4 is applied on an upper surface of the above-mentioned submerged nozzle 6, and the submerged nozzle and the lower nozzle are sealingly engaged with each other through the seal material.

Patent Document 1: Japanese Patent No. 3834741

Patent Document 2: Japanese Patent Application Laid-open No. Hei 10-99947

Patent Document 3: Japanese Utility Model Registration No. 3009112

Patent Document 4: Japanese Patent No. 3108372

### DISCLOSURE OF THE INVENTION

### Problems to be Solved by the Invention

The conventional submerged nozzle supporting-replacing mechanisms are structured as described above, and hence there are the following problems.

That is,

(1) In a case of the conventional structure 1 of FIG. 9,

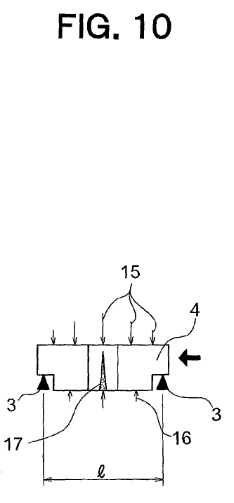

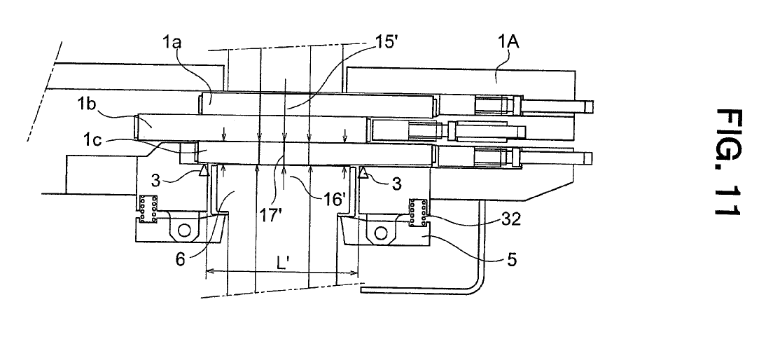

the lower nozzle 4 is supported by the receiving member 3 serving as a supporting point. A contact-pressure force 15 is applied to the lower nozzle 4 from above. Meanwhile, a pressing force 16 by the submerged nozzle 6 is applied to the lower nozzle 4 from below. The forces from above and below are applied to the lower nozzle 4 at strength corresponding to illustrated vectors (upward arrow and downward arrow) due to thermal expansion of brick. As a result, a vertical cracking 17 illustrated in FIG. 10 may be generated, and hence the air may be entrapped into the lower nozzle 4 and the lower nozzle 4 may be subject to melting damage, which leads to a reduced life time. In the worst case, steel may be leaked. In addition, due to the entrapped air, there are adverse effects in that the molten metal passing through a hole 13 is oxidized, which leads to a lower quality of a final product, etc.

(2) In a case of the conventional structure 2 of FIG. 11,

the lower plate 1c is supported by the receiving member 3. A contact-pressure force 15′ is applied to the lower plate 1c from above. Meanwhile, a pressing force 16′ by the submerged nozzle 6 is applied to the lower plate 1c from below. The forces from above and below are applied to the lower plate 1c at strength corresponding to illustrated vectors (upward arrow and downward arrow) due to thermal expansion of brick. As a result, a vertical cracking 17′ maybe generated, and hence the air maybe entrapped into the lower plate 1c and the lower plate 1c may be subject to melting damage, which leads to a reduced life time. In the worst case, steel may be leaked. There is a defect in that the same problems as those of the conventional structure 1 occur.

The conventional structure 2 is believed to have a better sealing property because the conventional structure 2 has fewer joint surfaces between fire-proof objects by one than the conventional structure 1. However, the conventional structure 2 has a supporting span L′ larger than that of the conventional structure 1, and hence a larger cracking may be easily generated.

(3) In the conventional structure 3 of FIG. 12,

the lower plate 1c is supported by the receiving member 3. A contact-pressure force 15″ is applied to the lower plate 1c from above. Meanwhile, a pressing force 16″ by the submerged nozzle 6 is applied to the lower plate 1c from below. The forces from above and below are applied to the lower plate 1c at strength corresponding to illustrated vectors (upward arrow and downward arrow) due to thermal expansion of brick. As a result, a vertical cracking 17″ may be generated, and hence the air may be entrapped into the lower plate 1c and the lower plate 1c may be subject to melting damage, which leads to a reduced life time. In the worst case, steel may be leaked. There is a problem in that the same problems as those of the conventional structures 1 and 2 occur.

The conventional structure 3 has a wide supporting span L′ similarly to the conventional structure 2 and a large height dimension, and hence a larger cracking may be easily generated.

Note that, in this structure, an effect of reducing crackings is obtained by restraining a periphery of a nozzle portion 1c′ of the lower plate 1c by the strong iron case 4G or the like. However, there is a defect in that the cost for the strong case is increased.

(4) In the conventional structure 4,

the seal material to be used is applied on a joint surface for the submerged nozzle. As a result, in a case where the cracking 17 of FIG. 9 is small, an effect of preventing the entrapped air is obtained because a better sealing property is obtained. However, in a case where the cracking becomes a little larger, the effect is not obtained, that is, the air is entrapped.

Further, the following phenomenon occurs. Specifically, after an outer peripheral portion of an upper surface of the submerged nozzle and an outer peripheral portion of a lower surface of the lower nozzle are fixed to each other through the seal material, the outer peripheral portion of the upper surface of the submerged nozzle is separated therefrom, and then, are fixed again to a side of the lower nozzle. In this way, there is a defect in that it is impossible to use the submerged nozzle supporting-replacing mechanism at multiple times.

### Means for Solving the Problems

According to the present invention, there is provided a submerged nozzle supporting-replacing mechanism. In the submerged nozzle supporting-replacing mechanism, an upper surface formed of a plane of a submerged nozzle is pressed through each of clampers with respect to a lower joint surface of a lower nozzle supported by a receiving member of a lower frame of a slide valve device, and the submerged nozzle is caused to slide so as to be replaced by a subsequent and fresh submerged-nozzle. The submerged nozzle supporting-replacing mechanism includes a ring-shaped taper portion formed in the lower nozzle; and a receiving taper portion formed in the receiving member. The submerged nozzle supporting-replacing mechanism has a structure in which the ring-shaped taper portion is joined onto the receiving taper portion. Further, the submerged nozzle supporting-replacing mechanism has another structure in which a tilted angle of the ring-shaped taper portion is set to 30° to 60°. Further, the submerged nozzle supporting-replacing mechanism has still another structure in which a shape of the lower nozzle includes: a maximum diameter; a first axial-direction-height indicating an entire height in an axial direction of the lower nozzle; and a second axial-direction-height measured from the ring-shaped taper portion up to the upper surface in the first axial-direction-height. In this case, when the maximum diameter is set to 1, the first axial-direction-height is set to 0.15 to 0.5. When the first axial-direction-height is set to 1, the second axial-direction-height is set to 0.15 to 0.5. Further, the submerged nozzle supporting-replacing mechanism further includes: a ring-shaped groove formed in the upper surface of the submerged nozzle; and a seal material filled in the ring-shaped groove. Further, according to the present invention, there is provided a lower-nozzle/submerged-nozzle sealing method. In the lower-nozzle/submerged-nozzle sealing method, there is used a submerged nozzle supporting-replacing mechanism, in which an upper surface formed of a plane of a submerged nozzle is pressed through each of clampers with respect to a lower joint surface of a lower nozzle supported by a receiving member of a lower frame of a slide valve device and the submerged nozzle is caused to slide so as to be replaced by a subsequent and fresh submerged-nozzle. The lower-nozzle/submerged-nozzle sealing method includes: joining a ring-shaped taper portion, which is formed in the lower nozzle, to a receiving taper portion, which is formed in the receiving member; and joining the submerged nozzle, which includes a seal material filled in a ring-shaped groove of the upper surface, to the lower nozzle so as to perform sealing between the lower nozzle and the receiving member. Further, in the lower-nozzle/submerged-nozzle sealing method, a tilted angle of the ring-shaped taper portion is set to 30° to 60°.

### Effects of the Invention

The submerged nozzle supporting-replacing mechanism and the lower-nozzle/submerged-nozzle sealing method according to the present invention are structured as described above, and hence the following effects can be obtained.

That is, in the structure according to claim 1, in the submerged nozzle supporting-replacing mechanism, the upper surface formed of the plane of the submerged nozzle is pressed through each of the clampers with respect to the lower surface of the lower nozzle supported by the receiving member of the lower frame of the slide valve device, and the submerged nozzle is caused to slide so as to be replaced by the subsequent and fresh submerged-nozzle. The submerged nozzle supporting-replacing mechanism includes: the ring-shaped taper portion formed in the lower nozzle; and the receiving taper portion formed in the receiving member. The ring-shaped taper portion is joined onto the receiving taper portion. Thus, a force toward the center thereof acts so as to prevent the vertical cracking. Further, a bending stress is alleviated. Therefore, it is possible to prevent extension of the cracking, and hence a seal property is improved.

Further, as in claims 4 and 5, the submerged nozzle supporting-replacing mechanism is used in which the upper surface formed of the plane of the submerged nozzle is pressed through each of the clampers with respect to the lower surface of the lower nozzle supported by the receiving member of the lower frame of the slide valve device and the submerged nozzle is caused to slide so as to be replaced by the subsequent and fresh submerged-nozzle. The ring-shaped taper portion, which is formed in the lower nozzle, is joined to the receiving taper portion, which is formed in the receiving member. The submerged nozzle, which includes the seal material filled in the ring-shaped groove of the upper surface of the submerged nozzle, is joined to the lower nozzle so as to perform sealing between the lower nozzle and the submerged nozzle. Thus, the upper surface of the submerged nozzle is fixed and joined to the lower surface of the lower nozzle without being separated therefrom after that, and hence it is possible to ensure the seal property. Therefore, it is possible to use the submerged nozzle supporting-replacing mechanism at multiple times.

Therefore, in the conventional structures, the bending stress is generated in the lower nozzle with a result that the vertical cracking is generated in the nozzle hole. However, according to the above-mentioned structure and method of the present invention, generation of the bending stress is reduced in the lower nozzle and it is possible to suppress the vertical cracking in the nozzle hole in an extremely effective manner.

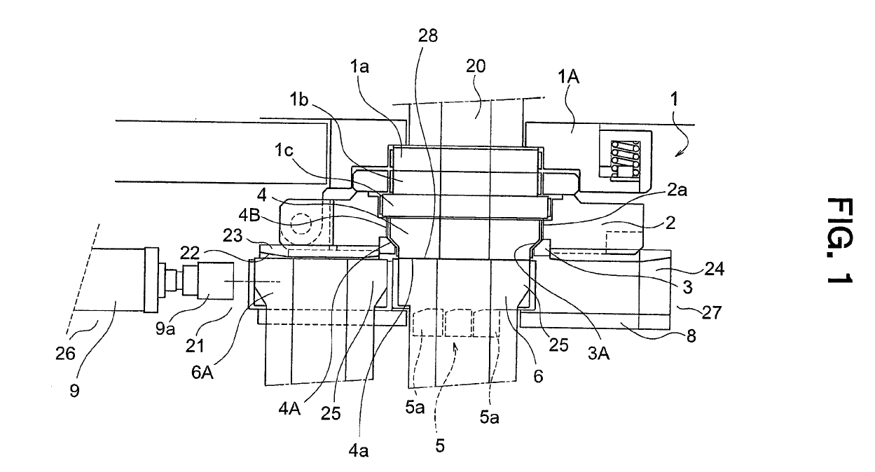

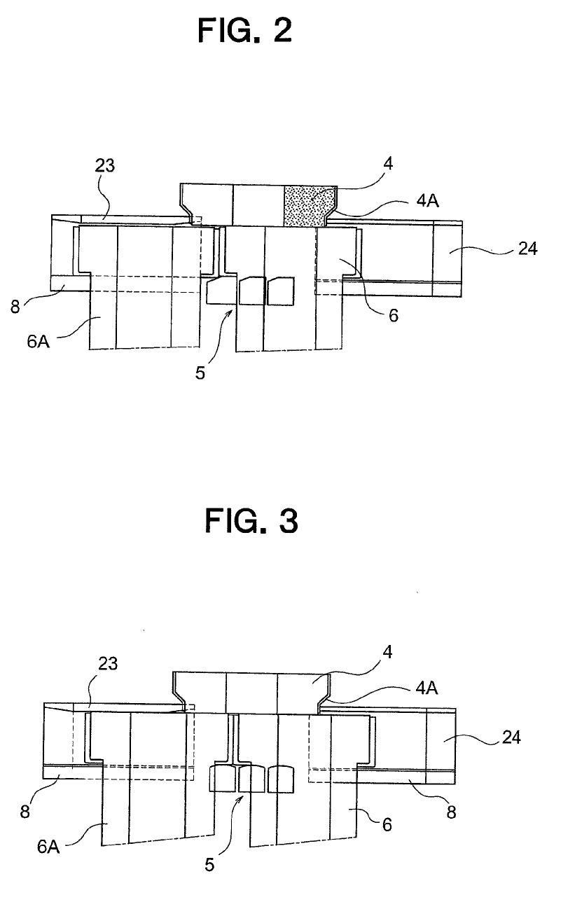

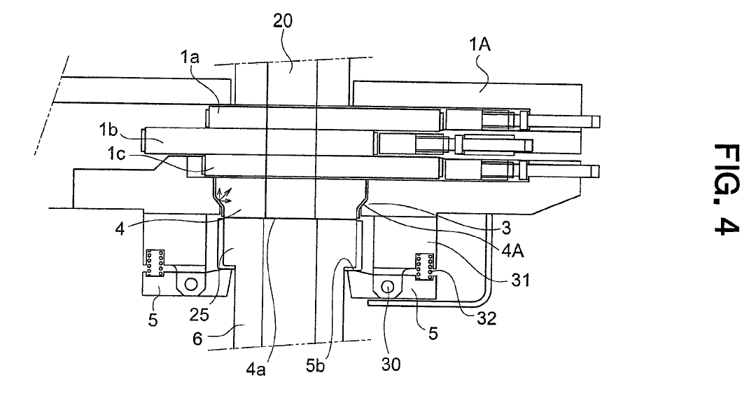

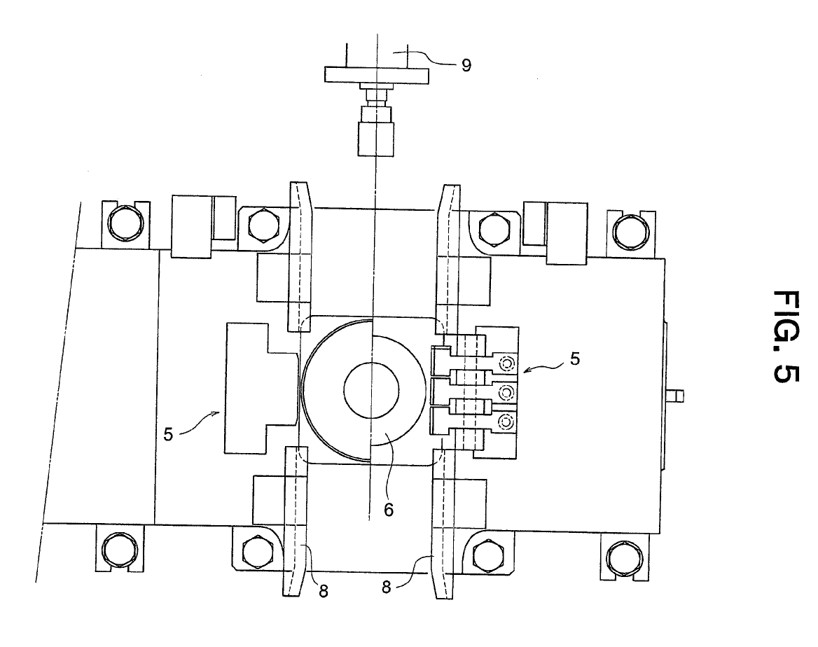

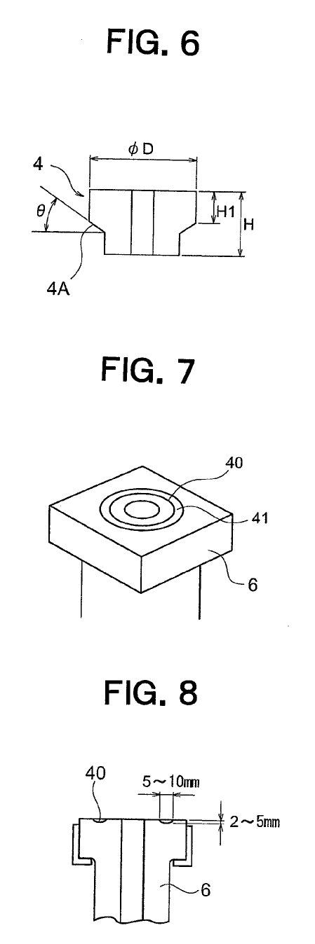

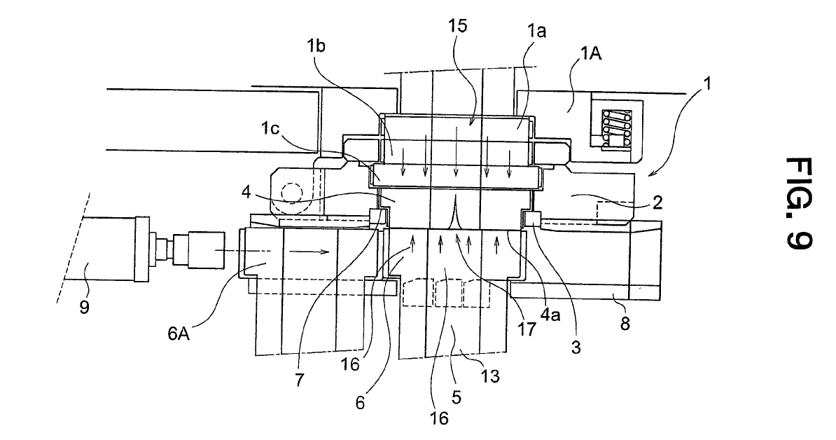

### BRIEF DESCRIPTION OF THE DRAWINGS

[FIG. 1] A cross-sectional view illustrating a submerged nozzle supporting-replacing mechanism according to the present invention.

[FIG. 2] An explanation view illustrating a replacement-starting state of a submerged nozzle in FIG. 1.

[FIG. 3] An explanation view illustrating a state in which the replacement of FIG. 2 is progressed.

[FIG. 4] A side cross-sectional view of FIG. 1.

[FIG. 5] A bottom view of FIG. 4.

[FIG. 6] A schematic view illustrating a shape and a dimension of a lower nozzle of FIG. 1.

[FIG. 7] An enlarged perspective view illustrating the submerged nozzle of FIG. 1.

[FIG. 8] A cross-sectional view of FIG. 7.

[FIG. 9] A cross-sectional view illustrating a submerged nozzle supporting-replacing mechanism of a conventional structure 1.

[FIG. 10] An explanation view illustrating a vertical cracking of a lower nozzle 4 of FIG. 9.

[FIG. 11] A cross-sectional view illustrating a submerged nozzle supporting-replacing mechanism of a conventional structure 2.

[FIG. 12] A cross-sectional view illustrating a submerged nozzle supporting-replacing mechanism of a conventional structure 3.

### BEST MODE FOR CARRYING OUT THE INVENTION

It is an object of the present invention to provide a submerged nozzle supporting-replacing mechanism and a lower-nozzle/submerged-nozzle sealing method of alleviating a bending stress to be applied to a lower nozzle, by joining a ring-shaped taper portion of the lower nozzle to a receiving taper portion of a receiving member, to thereby prevent generation of a vertical cracking, and further of sealingly engage a submerged nozzle with respect to the lower nozzle with a seal material provided to a ring-shaped groove.

### Example

Hereinafter, a preferred embodiment of a submerged nozzle supporting-replacing mechanism and a lower-nozzle/submerged-nozzle sealing method according to the present invention is described with reference to the drawings.

Note that, the description thereof is made in which parts identical or equivalent to those of the conventional examples are denoted by the same reference symbols.

In FIG. 1, a slide valve device 1 mainly includes an upper plate 1a, a slide plate 1b, and a lower plate 1c, which are arranged inside a base frame 1A similarly to the known slide valve device. An opening 2a is formed in a lower frame 2 of the slide valve device 1. The opening 2a is provided with a lower nozzle 4 continuous with a tapping hole 20.

In a lower surface of the lower frame 2, there is provided a positioning liner 23, which includes a taper surface 22 formed toward an inserting position 26. A pair of guide rails 8 is provided to a lower portion of a frame 24, which is formed so as to be suspended from the lower surface of the lower frame 2. In this structure, a submerged nozzle 6 and a subsequent and fresh submerged-nozzle 6A for replacement can be extruded and moved through a flange portion 25 by a pushing portion 9a of an extruding device 9 in a horizontal direction on guide rails 8.

In this structure, the fresh submerged-nozzle 6A is positioned at the inserting position 26, and the submerged nozzle 6 can be removed at a removing position 27. It is possible to detachably provide the extruding device 9 to the slide valve device 1 or a container for molten metal, such as a tundish (not shown). Note that, joint surfaces of upper surfaces 28 of the submerged nozzles 6 and 6A are structured so as to be equivalent in size to a lower joint surface 4a of the lower nozzle 4.

Further, a ring-shaped taper portion 4A is formed in a lower outer periphery of the lower nozzle 4. The ring-shaped taper portion 4A is jointed to a receiving taper portion 3A, which is formed in an inner periphery of the receiving member 3. Note that, actually, an iron cover 4B is formed in an outer periphery of the lower nozzle 4, and the iron cover 4B is jointed to an outer surface of the receiving taper portion 3A.

On a lower surface of the frame 24, there is provided a pair of first and second clampers 5 and 5. The clampers 5 and 5 are opposed to each other while sandwiching the submerged nozzle 6 along a direction orthogonal to a longitudinal direction of each of the guide rails 8.

Each of the clampers 5 and 5 includes a plurality of, that is, three clamper pieces 5a, which are provided in parallel to each other. As illustrated in FIG. 4, each of the clamper pieces 5a and 5a is structured such that its tip end upper portion 5b can come into contact and slide-contact with the lower surface of the flange 25.

Each of the clamper pieces 5a is axially supported by a pin 30 supported by the lower frame 2 so that each of the clamper pieces 5a is allowed to oscillate. Compression-type springs 32 are provided in supporting protrusions 31, which are provided to the lower frame 2 so as to be suspended from the lower frame 2. The compression-type springs 32 push rear portions of the clamper pieces 5a. Thus, the tip end upper portion 5b comes into contact with a flange lower surface of the flange 25 so as to be biased. Thus, in this way, the flange 25 comes into contact with the lower joint surface 4a of the lower nozzle 4.

In the above-mentioned structure, the description thereof is made with regard to a case where the upper surface of the submerged nozzle 6 is formed into only a plane. However, as illustrated in FIG. 7 and FIG. 8, the present invention has the following structure. Specifically, a ring-shaped groove 40 is formed. The ring-shaped groove 40 is filled with a flexible seal material 41. Thus, when the submerged nozzle 6 is jointed to the lower joint surface 4a of the lower nozzle 4, a sealingly engaging state of the lower nozzle 4 and the submerged nozzle 6 can be obtained.

Note that, the seal material 41 may include the known seal material, which is disclosed by the applicant of the present invention in Japanese Patent No. 3108372, for example.

Further, it is optimum that, as a dimension of a shape of the ring-shaped groove 40, for example, the ring-shaped groove 40 has a groove width of 5 to 10 mm, and a groove depth of 2 to 5 mm.

Next, in the above-mentioned structure, a case of actuating the submerged nozzle supporting-replacing mechanism according to the present invention is described.

In the state of FIG. 1, the submerged nozzle 6 during casting from a tundish (not shown) to a mold is illustrated, and the submerged nozzle 6 is upwardly biased by each of the clampers 5 and 5 to the lower joint surface 4a of the lower nozzle 4 continuous with the tapping hole 20.

In the above-mentioned state, in order to replace the submerged nozzle 6 with the fresh submerged-nozzle 6A with respect to the lower nozzle 4, the following processes are performed. Specifically, the fresh submerged-nozzle 6A is inserted into between the guide rails 8 and the positioning liner 23. The fresh submerged-nozzle 6A is pushed by the extruding device 9 to the right in FIG. 1. Then, as illustrated in FIG. 2, the submerged nozzle 6 is pushed by the moving fresh submerged-nozzle 6A so as to slide on each of the clampers 5 and 5.

The fresh submerged-nozzle 6A is further pushed by the extruding device 9. Then, the submerged nozzle 6 is caused to release correspondence with the lower nozzle 4 and is downwardly removed from the removing position 27. Further, the fresh submerged-nozzle 6A obtains the correspondence with the lower nozzle 4, and is upwardly pushed by each of the clampers 5 and 5. In this way, a replacement work is completed.

For the above-mentioned replacement of the submerged nozzle 6, when the fresh submerged-nozzle 6A moving on the guide rails 8 moves up to the tapping hole 20 of the lower nozzle 4, an inner surface of the positioning liner 23 is provided so as to be flush with or be positioned slightly below the lower joint surface 4a, and hence the upper surface 28 of the fresh submerged-nozzle 6A does not rise over the lower joint surface 4a of the lower nozzle 4. Thus, it is possible to perform a nozzle replacement in a state in which damages and the like are prevented from occurring in the upper surface of the fresh submerged-nozzle 6A.

In the above-mentioned case, the receiving taper portion 3A of the receiving member 3 comes into contact with and is joined to the ring-shaped taper portion 4A of the lower nozzle 4. Thus, a bending stress applied to the lower nozzle 4 due to a pressing force from the submerged nozzle 6 is dispersed to multiple directions and is reduced as illustrated by the arrow of FIG. 4. Therefore, it is possible to suppress generation of a vertical cracking in a hole of the lower nozzle 4.

Further, it was experimentally demonstrated that the ring-shaped taper portion 4A of the lower nozzle 4 has a taper shape of 45° as its optimum value. Due to this taper shape, the contact-pressure force of a perpendicular direction is converted into a force of a horizontal direction, and hence a restraint force toward the center thereof acts on the lower nozzle 4 by the receiving member 3. As a test result, there was observed an effect in which, due to the restraint force, the cracking may be generated, but, even in this case, the generated cracking does not extend.

Further, as the test result, it was demonstrated that there was a range of a more effective shape.

The more effective shape of the lower nozzle 4 is, as illustrated in FIG. 6, the following range.
ΦD 1 (ΦD as a reference) θ=30 to 60°
H 0.15 to 0.5 1 (H as a reference)
H1 0.15 to 0.5

Note that, a maximum diameter of the lower nozzle 4 is represented by OD, a first axial-direction-height indicating an axial-direction-height of the entire is represented by H, a second axial-direction-height indicating an axial-direction-height measured upwardly from the ring-shaped taper portion 4A is represented by H1, and a tilted angle of the ring-shaped taper portion 4A is represented by θ.

Further, if the angle exceeds 60°, though a cracking extension preventing effect is increased, a position shift in an upper and lower direction increases due to variation of angles of products. Therefore, that is not for practical use.

Further, the ring-shaped groove 40 of a ring-shape was arranged in a middle portion positioned between the hole, through which the molten metal passes, and an outer peripheral portion in a plane of a joint portion in the upper surface of the submerged nozzle as illustrated in FIG. 7 and FIG. 8, and was filled with the seal material 41.

### Specific Example

(1) An Example of a Shape of the Lower Nozzle
ΦD=200 The iron case is set in the outer periphery of the lower nozzle
H=60 taper angle=45°
H1=15

It was confirmed that, when the lower nozzle having this shape is used, the extremely thin cracking may be generated, but, even in this case, the generated cracking does not extend.

(2) A submerged nozzle was used, in which an upper surface of the submerged nozzle was provided with a groove exhibiting a semi-ellipse shape in section, and the groove was filled with the seal material.

A dimension of the groove was set to have a width of 10 mm and a depth of 5 mm.

Ranges of effective dimensions are 5 to 15 mm of a width and 2 to 10 mm of a depth.

1. A submerged nozzle supporting-replacing mechanism, in which an upper surface (28) formed of a plane of a submerged nozzle (6) is pressed through each of clampers (5) with respect to a lower joint surface (4a) of a lower nozzle (4) supported by a receiving member (3) of a lower frame (2) of a slide valve device (1) and the submerged nozzle (6) is caused to slide so as to be replaced by a subsequent and fresh submerged-nozzle (6A), the submerged nozzle supporting-replacing mechanism comprising:
a ring-shaped taper portion (4A) formed in the lower nozzle (4); and
a receiving taper portion (3A) formed in the receiving member (3),
wherein the ring-shaped taper portion (4A) is joined onto the receiving taper portion (3A).

2. A submerged nozzle supporting-replacing mechanism according to claim 1, wherein the ring-shaped taper portion (4A) is set to have a tilted angle of from 30° to 60°.

3. A submerged nozzle supporting-replacing mechanism according to claim 1, wherein:
a shape of the lower nozzle (4) comprises:
a maximum diameter (ΦD);
a first axial-direction-height (H) indicating an entire height in an axial direction of the lower nozzle (4); and
a second axial-direction-height (H1) measured from the ring-shaped taper portion (4A) up to the upper surface (28) in the first axial-direction-height (H);
when the maximum diameter (ΦD) is set to 1, the first axial-direction-height (H) is set to 0.15 to 0.5; and
when the first axial-direction-height (H) is set to 1, the second axial-direction-height (H1) is set to 0.15 to 0.5.

4. A submerged nozzle supporting-replacing mechanism according to claim 1, further comprising:
a ring-shaped groove (40) formed in the upper surface (28) of the submerged nozzle (6); and
a seal material (41) filled in the ring-shaped groove (40).

5. A lower-nozzle/submerged-nozzle sealing method, in which a submerged nozzle supporting-replacing mechanism is used, the submerged nozzle supporting-replacing mechanism being configured so that an upper surface (28) formed of a plane of a submerged nozzle (6) is pressed through each of clampers (5) with respect to a lower joint surface (4a) of a lower nozzle (4) supported by a receiving member (3) of a lower frame (2) of a slide valve device (1) and the submerged nozzle (6) is caused to slide so as to be replaced by a subsequent and fresh submerged-nozzle (6A), the lower-nozzle/submerged-nozzle sealing method comprising:
joining a ring-shaped taper portion (4A), which is formed in the lower nozzle (4), to a receiving taper portion (3A), which is formed in the receiving member (3); and
joining the submerged nozzle (6), which comprises a seal material (41) filled in a ring-shaped groove (40) of the upper surface (28), to the lower nozzle (4) so as to perform sealing between the lower nozzle (4) and the submerged nozzle (6).

6. A lower-nozzle/submerged-nozzle sealing method according to claim 5, wherein the ring-shaped taper portion (4A) is set to have a tilted angle of from 30° to 60°.

7. A submerged nozzle supporting-replacing mechanism according to claim 2, wherein:
a shape of the lower nozzle (4) comprises:
a maximum diameter (ΦD);
a first axial-direction-height (H) indicating an entire height in an axial direction of the lower nozzle (4); and
a second axial-direction-height (H1) measured from the ring-shaped taper portion (4A) up to the upper surface (28) in the first axial-direction-height (H);
when the maximum diameter (ΦD) is set to 1, the first axial-direction-height (H) is set to 0.15 to 0.5; and
when the first axial-direction-height (H) is set to 1, the second axial-direction-height (H1) is set to 0.15 to 0.5.
